(19) United States
(12) Patent Application Publication
(10) Pub. No.: US 2015/0277527 A1
(43) Pub. Date: Oct. 1, 2015

(54) USB hub, control module of USB hub and method of controlling USB hub

(71) Applicant: REALTEK SEMICONDUCTOR CORPORATION, HSINCHU (TW)

(72) Inventor: Chong Liu, Jiangsu Province (CN)

(21) Appl. No.: 14/665,665

(22) Filed: Mar. 23, 2015

(30) Foreign Application Priority Data
Mar. 25, 2014 (CN) 201410115090.9

(51) Int. Cl. G06F 1/26

(52) U.S. Cl. CPC G06F 1/266

(57) ABSTRACT

This invention discloses a control module of a USB hub. The USB hub utilizes an output switch to selectively output a supplying power through a power supply output and utilizes a capacitor to stabilize a voltage at the power supply output. The control module includes: a switch; a discharge resistor, which is coupled to the capacitor via the switch; a control unit for generating a power control signal; and a logic circuit, which controls the output switch whether to output the supplying power or not and controls the conduction state of the switch according to the power control signal. When the power control signal indicates that the logic circuit should control the output switch not to output the supplying power, the logic circuit controls the switch to be on so that the capacitor discharges through the discharge resistor, causing the voltage at the power supply output to decrease.

### BACKGROUND OF THE INVENTION

1. Field of the Invention

This invention relates to a USB (Universal Serial Bus) hub, especially to a control module and the method thereof of the USB hub that force an output voltage at the downstream port to decrease rapidly after the USB hub stops supplying power, without increasing overall power consumption.

2. Description of Related Art

A USB becomes a common port in electronic devices because of its hot-plug feature and the capability of supplying power and transmitting data at the same time. Please refer to FIG. 1, illustrating a circuit of a conventional USB hub. The USB hub 100 comprises a hub control module 110 and an output switch 120. The hub control module 110 is connected to a USB host (not shown) and controls the power supply and data transmission from the USB host to the downstream port. The output switch 120 which is connected to the hub control module 110 determines whether to output the power source Vs via the downstream port based on a power enabling signal Power_EN of the hub control module 110 such that the supplying power VBUS will be provided to an USB device connected to the downstream port. Another function of the output switch 120 is to detect whether an output current at the downstream port is too large. To be specific, when the connected USB device is broken, which may probably draw too much current from the USB hub 100, the output switch 120 will send an OCP (overcurrent protection) signal to the hub control module 110, which, in response to the OCP signal, changes the state of the power enabling signal Power_EN in order to prevent the output switch 120 from outputting the supplying power VBUS. In general, an OCP signal output of the output switch 120 is coupled to a voltage source (e.g., a 3.3V voltage source) through a pull-up resistor 150 so that the OCP signal is at high level when the USB hub 100 is in normal operation. When an abnormal situation occurs, e.g., the output current at the downstream port is too high, the output switch 120 changes the OCP signal to low level to notify the hub control module 110.

In order to make an output voltage at the downstream port stable, the downstream port is usually coupled to a capacitor 130 that has a high capacitance. The capacitor 130, however, has a drawback that the downstream port will be kept at high voltage level due to the terminal voltage of the capacitor 130 when the hub control module 110 controls the output switch 120 to stop providing power to the downstream port. The high voltage will cause the USB device connected to the port not to effectively detect that the power source VBUS at the downstream port has been closed. For example, a USB device is connected to a host via USB, and when the upstream port of the USB is disconnected from the host and then connected back to the host in a very short time, the hub control module 110 makes the output switch 120 stop providing the supplying power VBUS during this disconnection period and makes the output switch 120 provide the supplying power VBUS again after the connection is restored; however, the USB device cannot detect the process of losing and regaining of the power source due to the capacitor 130. This situation may cause some compatibility problems to the USB device.

To solve the above problem, a discharge resistor 140 is coupled to the power supply output of the USB hub 100 so that when the USB hub 100 stops providing power, the capacitor 130 can discharge rapidly through the discharge resistor 140; as a result, the USB device is able to detect the real-time power supply status of the USB hub 100. However, the discharge resistor 140 increases the overall power consumption of the USB hub 100. Another method to address the above problem is to install the discharge resistor in the connected USB device instead of in the USB hub 100. This approach, however, increases the cost of the USB device and also increases the overall power consumption when the USB device is connected to the USB hub.

### SUMMARY OF THE INVENTION

In consideration of the imperfections of the prior art, an object of the present invention is to provide a USB hub, a control module of a USB hub and method of controlling a USB hub, so as to make an improvement to the prior art.

The present invention discloses a USB hub for providing a supplying power. The USB hub comprises an output switch, selectively outputting the supplying power at a power supply output; a capacitor, coupled to the power supply output, for stabilizing a voltage at the power supply output; and a hub control module, coupled to the output switch and the capacitor. The hub control module comprises a switch, coupled to the capacitor; a discharge resistor, coupled to the capacitor through the switch; a control unit for generating a power control signal; and a logic circuit, coupled to the control unit, the output switch and the switch, for controlling the output switch whether to output the supplying power or not and controlling a conduction state of the switch according to the power control signal. When the power control signal instructs the logic circuit to control the output switch not to output the supplying power, the logic circuit controls the switch to be on such that the capacitor discharges through the discharge resistor and the voltage at the power supply output decreases accordingly.

The present invention also discloses a control module of a USB hub. The USB hub utilizes an output switch to selectively output a supplying power through a power supply output and utilizes a capacitor to stabilize a voltage at the power supply output. The control module comprises a switch, coupled to the capacitor; a discharge resistor, coupled to the capacitor through the switch; a control unit for generating a power control signal; and a logic circuit, coupled to the control unit, the output switch and the switch, for controlling the output switch whether to output the supplying power or not and controlling a conduction state of the switch according to the power control signal. When the power control signal instructs the logic circuit to control the output switch not to output the supplying power, the logic circuit controls the switch to be on such that the capacitor discharges through the discharge resistor and the voltage at the power supply output decreases accordingly.

The present invention further discloses a method of controlling a USB hub. The USB hub utilizes an output switch to selectively output a supplying power through a power supply output and utilizes a capacitor to stabilize a voltage at the power supply output. The USB hub further comprises a control unit for outputting a power control signal. The method comprises steps of: providing a switch; providing a discharge resistor, coupled to the capacitor through the switch; controlling the output switch whether to output the supplying power or not according to the power control signal; and selectively controlling the switch to be off or on according to an output state of the supplying power to make the capacitor charge or discharge through the discharge resistor.

This invention, which includes a USB hub, a control module of the USB hub, and a method of controlling the USB hub, is able to decrease the voltage at the downstream port rapidly after the supplying power is stopped such that a USB device can detect the real-time power supply status. In comparison with the prior art, the discharge resistor installed in the USB hub of the present invention does not increase the overall power consumption of the USB hub. In addition, the USB device connected to the USB hub of the present invention is not required to have an additional discharge resistor installed, which not only reduces the power consumption but also reduces the burden of manufacturing the USB device.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 illustrates a circuit of a conventional USB hub.

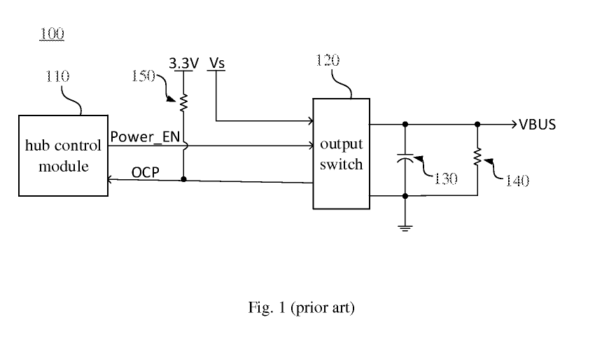

FIG. 2 illustrates a circuit of a USB hub according to an embodiment of the present invention.

FIG. 3 illustrates a circuit of a USB hub according to another embodiment of the present invention.

FIG. 4 illustrates a timing diagram of each signal when a USB hub starts to supply power.

FIG. 5 illustrates a timing diagram of each signal when a USB hub is about to stop supplying power.

FIG. 6 illustrates a timing diagram of each signal when an overcurrent protection happens to a USB hub.

FIG. 7 illustrates a flowchart of a method of controlling a USB hub according to an embodiment of this invention.

FIG. 8 illustrates a flowchart of the control method when the USB hub starts to supply power.

FIG. 9 illustrates a flowchart of the control method when the USB hub is about to stop supplying power.

FIG. 10 illustrates a flowchart of the control method when an overcurrent protection happens to a USB hub.

### DETAILED DESCRIPTION OF THE PREFERRED EMBODIMENTS

The following description is written by referring to terms of this invention field. If any term is defined in the specification, such term should be explained accordingly. Besides, the connection between objects or events in the following embodiments can be direct or indirect provided that these embodiments are still applicable under such connection. Said “indirect” means that an intermediate object or a physical space exists between the objects, or an intermediate event or a time interval exists between the events. The present invention discloses a USB hub, a control module of the USB hub, and a method of controlling the USB hub, and the detail known in this field will be omitted if such detail has little to do with the features of the present invention. People of ordinary skill in the art can choose components or steps equivalent to those described in this specification to carry out the present invention, which means that the scope of this invention is not limited to the embodiments in the specification. On account of that some or all elements of said device invention could be known, the detail of such elements will be omitted provided that this omission nowhere dissatisfies the specification and enablement requirements.

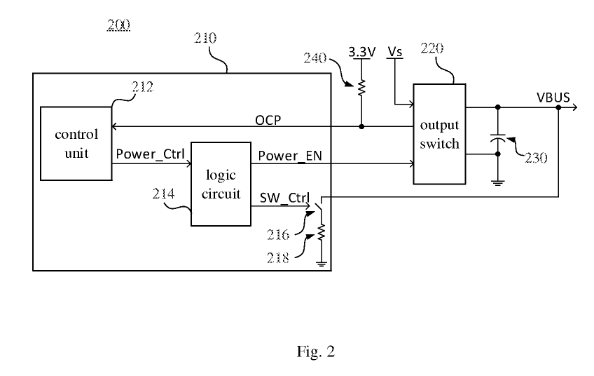

Please refer to FIG. 2, illustrating a circuit of a USB hub according to an embodiment of the present invention. The USB hub 200 mainly comprises a hub control module 210 and an output switch 220. The output switch 220 has similar functions to the output switch 120, and thus the detailed descriptions of the output switch 220 are omitted. In this embodiment, the power supply output, i.e., the downstream port of the USB hub 200, is not directly coupled to a discharge resistor but coupled to the hub control module 210 instead. The hub control module 210 comprises a control unit 212, a logic circuit 214, a switch 216, and a discharge resistor 218. The control unit 212 controls power supply and data transmission of the downstream port according to commands from a USB host (not shown). The logic circuit 214, which is coupled to the control unit 212, controls the output switch 220 and the conduction state of the switch 216 according to a power control signal Power_Ctrl generated by the control unit 212. The switch 216 is coupled to the power supply output of the output switch 220, i.e., coupled to the capacitor 230. The discharge resistor 218 is coupled to the capacitor 230 through the switch 216. When the control unit 212 changes the state of the power control signal Power_Ctrl, which, for example, indicates that the USB hub 200 should output the supplying power VBUS at the downstream port, the logic circuit 214 controls the output switch 220 to output the supplying power VBUS by changing the power enabling signal Power_EN and outputs a switch control signal SW_Ctrl to control the switch 216 to be off such that the capacitor 230 is able to charge to stabilize the voltage at the power supply output. On the other hand, when the power control signal Power_Ctrl indicates that the USB hub 200 should stop outputting the supplying power VBUS at the downstream port, for example simply closing the supply of the power or closing the supply of the power due to overcurrent protection, the logic circuit 214 controls the output switch 220 to stop outputting the supplying power VBUS by changing the power enabling signal Power_EN and outputs the switch control signal SW_Ctrl to control the switch 216 to be on such that the capacitor 230 is able to discharge rapidly through the discharge resistor 218. According to a capacitor discharge formula, Vₜ=V₀e^{t/RC}, assuming that the initial voltage V₀ is 5V and the capacitance C is 100 μF, the resistance R must not be greater than 19.6 kΩ to ensure that Vₜ becomes less than 3V in 1 second. In a preferred embodiment, the resistance of the discharge resistor 218 is 1 kΩ, and therefore it takes only 56.2 ms for the voltage at the power supply output to decrease from 5V to 3V.

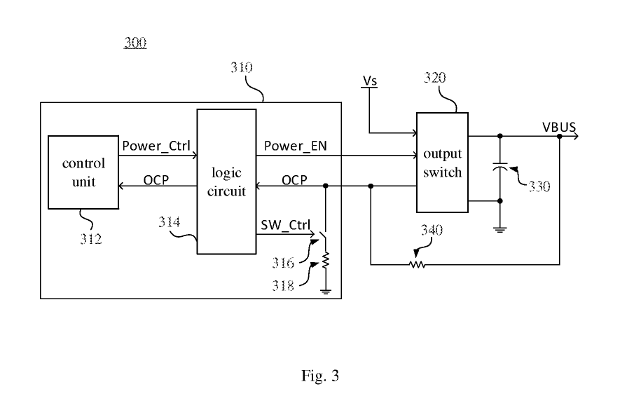

Please refer to FIG. 3, illustrating a circuit of a USB hub according to another embodiment of the present invention. A USB hub 300 in this embodiment comprises mainly a hub control module 310 and an output switch 320. The output switch 320 has similar functions to the output switch 120, and thus the detailed descriptions of the output switch 320 are omitted. In this embodiment, the power supply output, i.e., the downstream port of the USB hub 300, is not directly coupled to a discharge resistor but instead coupled to an OCP signal output. The hub control module 310 comprises a control unit 312, a logic circuit 314, a switch 316, and a discharge resistor 318. The logic circuit 314, which is similar to the logic circuit 214 of the previous embodiment, controls the output switch 320 whether to output the supplying power VBUS or not by generating a power enabling signal Power_EN according a power control signal Power_Ctrl, and controls the conduction state of the switch 316 by generating a switch control signal SW_Ctrl. However, the logic circuit 314 receives the OCP signal from the output switch 320 and determines whether to send the OCP signal to the control unit 312 or not. When the output switch 320 outputs the supplying power VBUS at the power supply output, the supplying power VBUS inherently pulls up the level at the OCP signal output through the protection resistor 340; therefore, the pull-up resistor 150 (240) and the 3.3V voltage source in the prior art or the previous embodiment can be saved. Note that the protection resistor 340 is mainly to prevent a large current from flowing into the OCP signal output of the output switch 320 to protect the output switch 320; however, if the output switch 320 is properly designed, the protection resistor 340 can be saved. In a preferred embodiment, the protection resistor 340 is designed to have a resistance of 100Ω. When an overcurrent protection occurs, the output switch 320 can still notify the hub control module 310 by pulling down the level at the OCP signal output. The detailed operating processes of the hub control module 310 under different circumstances will be illustrated by timing diagrams of each signal.

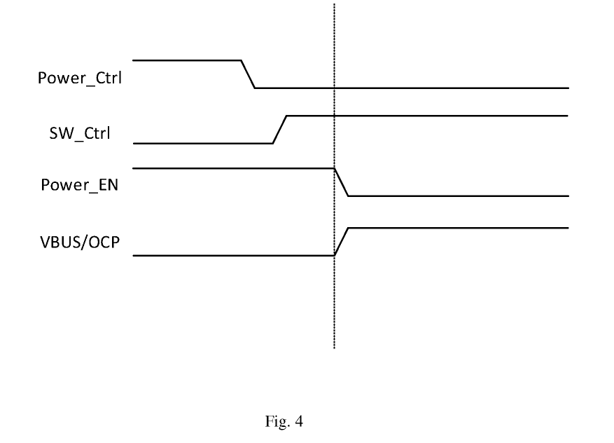

Please refer to FIG. 4, illustrating a timing diagram of each signal when a USB hub starts to supply power. In this and the following embodiments, signals are defined to be enabling at low level and non-enabling at high level. Alternatively, signals can be defined to be non-enabling at low level and enabling at high level. When the USB hub 300 is about to supply power, the control unit 312 first controls the power control signal Power_Ctrl to transit from high level to low level, and then the logic circuit 314 in turn controls the switch control signal SW_Ctrl to transit from low level to high level according to the transition of the power control signal Power_Ctrl. As a result, the switch 316 is off, ensuring that the capacitor 330 is able to charge as the output switch 320 outputs the supplying power VBUS. In addition, the logic circuit 314 controls, according to the power control signal Power_Ctrl, the power enabling signal Power_EN to transit from high level to low level, which controls the output switch 320 to start outputting the supplying power VBUS. When the supplying power VBUS starts to output (i.e., the supplying power VBUS transits from low level to high level), the level of the OCP signal is inherently pulled up. After the level at the OCP signal output is pulled up, the hub control module 310 starts to detect the OCP signal; namely, the logic circuit 314 starts to send the OCP signal to the control unit 312. On the other hand, when the USB hub 300 is not providing the supplying power VBUS, the logic circuit 314 does not send the OCP signal to the control unit 312. Please note that although the transition timing of the power enabling signal Power_EN is behind that of the switch control signal SW_Ctrl, they can actually transit at substantially the same time or the transition of the switch control signal SW_Ctrl happens slightly later than that of the power enabling signal Power_EN. In a preferred embodiment, the power enabling signal Power_EN is designed to transit after the transition of the switch control signal SW_Ctrl to further stabilize the output power.

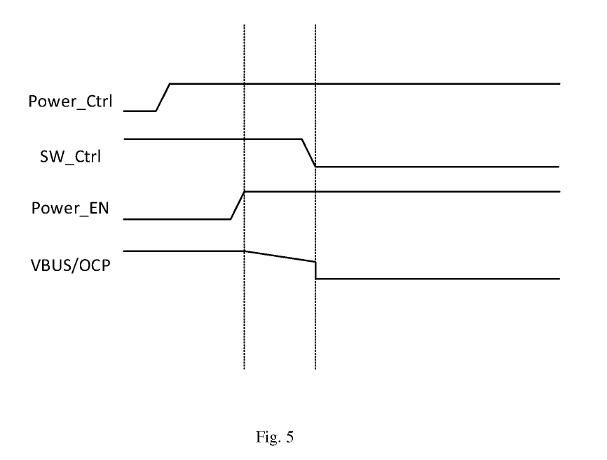

Please refer to FIG. 5, illustrating a timing diagram of each signal when a USB hub is about to stop supplying power. When the USB hub 300 is about to stop supplying power, the control unit 312 first controls the power control signal Power_Ctrl to transit from low level to high level, and then the logic circuit 314 in turn controls the power enabling signal Power_EN to transit from low level to high level according to the power control signal Power_Ctrl. As a result, the output switch 320 stops outputting the supplying power VBUS. When the supplying power VBUS stops outputting, the level of the OCP signal starts to decrease slowly because of the natural discharge of the capacitor 330. In addition, the logic circuit 314 controls the switch control signal SW_Ctrl to transit from high to low level, according to the transition of the power control signal Power_Ctrl, to switch on the switch 316. As a result, the capacitor 330 is able to discharge through the discharge resistor 318 and therefore the level of the OCP signal decreases rapidly. Because the level at the OCP signal output decreases as the supplying power VBUS stops outputting, to prevent the control unit 312 from mistakenly determining that an overcurrent protection occurs at the time, after receiving a notification to stop the supplying power VBUS from the control unit 312, the logic circuit 314 stops sending the OCP signal to the control unit 312 before controlling the power enabling signal Power_EN to transit; as a result, the hub control module 310 stops detecting the OCP signal. Please note that although the transition timing of the switch control signal SW_Ctrl is behind that of the power enabling signal Power_EN, they can actually transit at substantially the same time or the transition of the power enabling signal Power_EN happens slightly later than that of the switch control signal SW_Ctrl. In a preferred embodiment, the switch control signal SW_Ctrl is designed to transit after the transition of the power enabling signal Power_EN to further stabilize the output power.

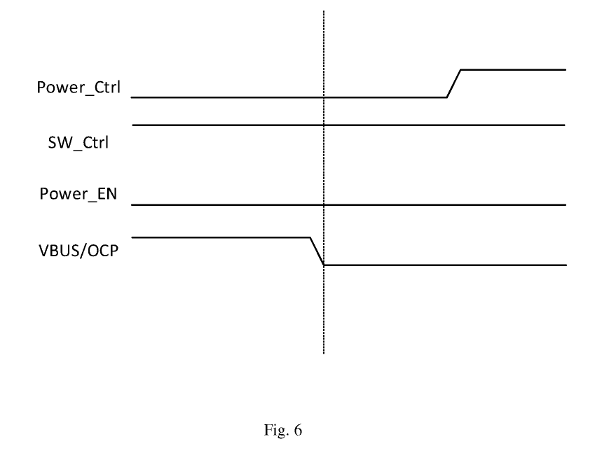

Please refer to FIG. 6, illustrating a timing diagram of each signal when an overcurrent protection happens to a USB hub. When an overcurrent protection happens, the OCP signal transits immediately from high level to low level. When detecting that the OCP signal transmitted from the logic circuit 314 transits, the control unit 312 controls the power control signal Power_Ctrl to transit from low level to high level to notify the logic circuit 314, which in turn controls the output switch 320 to stop supplying the supplying power VBUS. Afterwards, the transition of each signal is shown as FIG. 5.

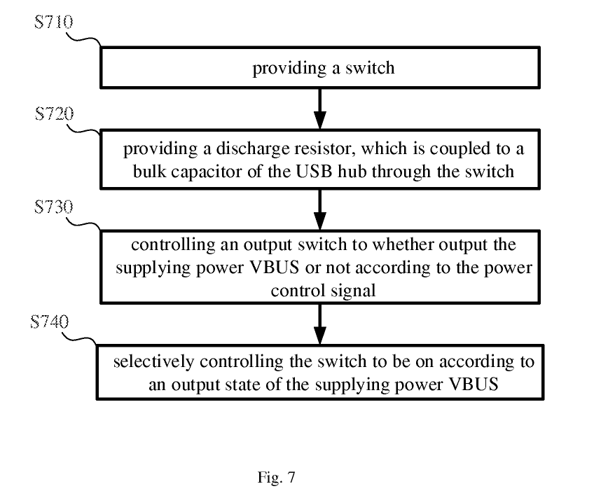

Please refer to FIG. 7, illustrating a flowchart of a method of controlling a USB hub according to an embodiment of this invention. In addition to the aforementioned USB hub and a control module of the USB hub, this invention correspondingly discloses a method of controlling a USB hub as well. After the USB hub stops supplying power, an output voltage at the output terminal of the USB hub decreases rapidly and the overall power consumption of the USB hub is not increased. This method can be performed by the hub control module 210, the hub control module 310 or their equivalent circuits. As shown in FIG. 7, the method of controlling a USB hub according to an embodiment of this invention comprises the following steps:

Step S710: providing a switch;

Step S720: providing a discharge resistor, which is coupled to a bulk capacitor of the USB hub through the switch. The bulk capacitor is for stabilizing the output voltage of the USB hub. When the switch is on, the bulk capacitor can discharge through the discharge resistor; and when the switch is off, the bulk capacitor can charge to stabilize the output voltage of the USB hub;

Step S730: controlling an output switch to whether output the supplying power VBUS or not according to the power control signal Power_Ctrl. The output switch is controlled to selectively output the supplying power VBUS. The bulk capacitor is coupled to the power supply output of the output switch; and

Step S740: selectively controlling the switch to be on according to an output state of the supplying power VBUS. When the power control signal Power_Ctrl instructs to control the output switch to output the supplying power VBUS, the switch is controlled to be off so that the bulk capacitor can charge to stabilize the output voltage; when the power control signal Power_Ctrl instructs to control the output switch to stop outputting the supplying power VBUS, the switch is controlled to be on so that the bulk capacitor can discharge through the discharge resistor to rapidly reflect the state of the output power of the USB hub.

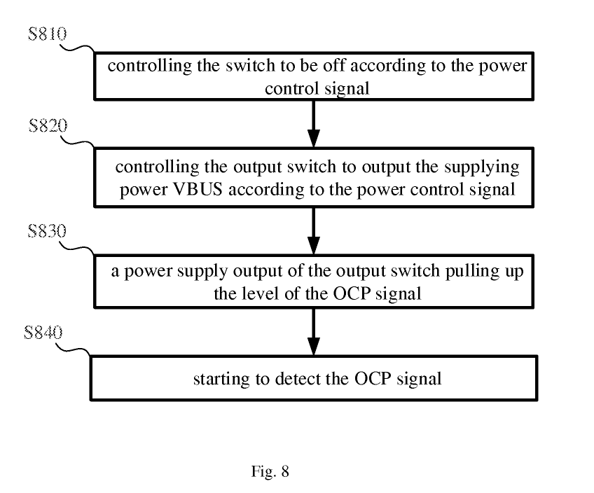

Another function of the output switch is to detect whether an output current at its power supply output, i.e., the downstream port of the USB hub, is too large or not. When the output current is too large, the output switch outputs the OCP signal via the OCP signal output; to be more specific, the output switch controls the OCP signal to transit. In addition, the power supply output is coupled to the OCP signal output to pull up the level at the OCP signal output when the supplying power VBUS is being outputted. Detailed processes of the method of controlling the USB hub are described according to different operating situations corresponding to FIGS. 4 to 6. Please refer to FIG. 8, illustrating a flowchart of the control method when the USB hub starts to supply power. Please also refers to FIG. 4. When the power control signal Power_Ctrl instructs the output switch to output the supplying power VBUS, the following steps are performed:

Step S810: controlling the switch to be off according to the power control signal Power_Ctrl. As shown in FIG. 4, after the power control signal Power_Ctrl transits the switch control signal SW_Ctrl also transits to control the switch to be off so that the bulk capacitor can charge;

Step S820: controlling the output switch to output the supplying power VBUS according to the power control signal Power_Ctrl. In response to a level transition from high level to low level of the power control signal Power_Ctrl, the power enabling signal Power_EN transits from high level to low level to control the output switch to output the supplying power VBUS;

Step S830: a power supply output of the output switch pulling up the level of the OCP signal. Because the power supply output of the output switch is coupled to its OCP signal output, when the supplying power VBUS is being outputted, the level of the OCP signal is pulled up accordingly; and

Step S840: starting to detect the OCP signal. After the level of the OCP signal is pulled up, the process starts to detect the OCP signal. Namely, instead of preventing the OCP signal from being transmitted to the control unit 312, the OCP signal is now being transmitted to the control unit 312.

Note that there is no limitation to the sequence of the step S810 and the step S820; one can be performed prior to the other or they can be performed at substantially the same time. In a preferred embodiment, the step S810 is performed prior to the step S820 to further stabilize the supplying power VBUS.

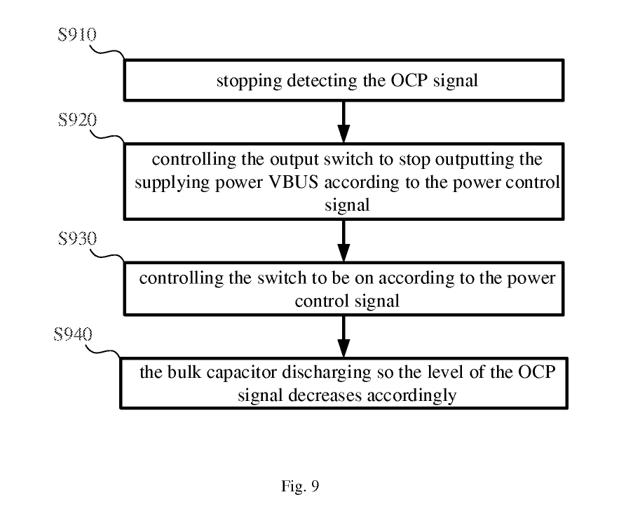

Please refer to FIG. 9, illustrating a flowchart of the control method when the USB hub is about to stop supplying power. Please also refer to FIG. 5. When the power control signal Power_Ctrl instructs the output switch to stop outputting the supplying power VBUS, the following steps are performed:

Step S910: stopping detecting the OCP signal. Because the output switch is about to stop outputting the supplying power VBUS, it is not required to detect the OCP signal anymore. Moreover, the level of the OCP signal will decrease after the supplying power VBUS stops outputting. To prevent the control unit 312 from misjudging, the hub control module 310 thus stops detecting the OCP signal, namely, stops sending the OCP signal to the control unit 312;

Step S920: controlling the output switch to stop outputting the supplying power VBUS according to the power control signal Power_Ctrl. In response to a level transition from low level to high level of the power control signal Power_Ctrl, the power enabling signal Power_EN transits from low level to high level to control the output switch to stop outputting the supplying power VBUS;

Step S930: controlling the switch to be on according to the power control signal Power_Ctrl. As shown in FIG. 5, after the power control signal Power_Ctrl transits the switch control signal SW_Ctrl also transits to control the switch to be on so that the bulk capacitor can discharge through the discharge resistor; and

Step S940: the bulk capacitor discharging so the level of the OCP signal decreases accordingly. Because the power supply output of the output switch is coupled to its OCP signal output, when the voltage of the bulk capacitor starts to decrease, the level of the OCP signal decreases accordingly.

Similarly, there is no limitation to the sequence of the step S920 and the step S930; one can be performed prior to the other or they can be performed at substantially the same time. In a preferred embodiment, the step S920 is performed prior to the step S930 to further stabilize the supplying power VBUS.

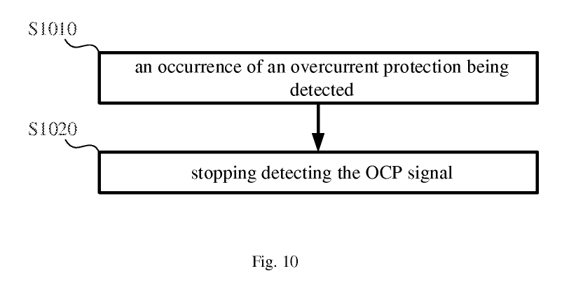

Please refer to FIG. 10, illustrating a flowchart of the control method when an overcurrent protection happens to a USB hub. Please also refer to FIG. 6. When an occurrence of an overcurrent protection is detected, the following steps are performed:

Step S1010: an occurrence of an overcurrent protection being detected. When the output current at the downstream port of the USB hub is too large, the output switch 320 changes the level of the OCP signal, for example, from high level to low level as shown in FIG. 6. Consequently, the control unit 312 is able to know an overcurrent protection occurs by detecting the level transition; and

Step S1020: stopping detecting the OCP signal. This step is substantially the same as the step S910, so the description is omitted for brevity.

In fact, after the step S1020 is complete, the steps shown in FIG. 9 can then be performed to stop outputting the supplying power VBUS and make the bulk capacitor discharge.

Since people of ordinary skill in the art can appreciate the implementation detail and the modification thereto of the present method invention of FIGS. 7 to 10 through the disclosure of the device invention of FIG. 3, repeated and redundant description is thus omitted. Please note that there is no step sequence limitation for the method inventions as long as the execution of each step is applicable. Furthermore, the shape, size, and ratio of any element and the step sequence of any flow chart in the disclosed figures are just exemplary for understanding, not for limiting the scope of this invention. Besides, each aforementioned embodiment may include one or more features; however, this doesn't mean that one carrying out the present invention should make use of all the features of one embodiment at the same time, or should only carry out different embodiments separately. In other words, if an implementation derived from one or more of the embodiments is applicable, a person of ordinary skill in the art can selectively make use of some or all of the features in one embodiment or selectively make use of the combination of some or all features in several embodiments to have the implementation come true, so as to increase the flexibility of carrying out the present invention.

The aforementioned descriptions represent merely the preferred embodiments of the present invention, without any intention to limit the scope of the present invention thereto. Various equivalent changes, alterations, or modifications based on the claims of present invention are all consequently viewed as being embraced by the scope of the present invention.

What is claimed is:

1. A USB hub for providing a supplying power, comprising:
an output switch, selectively outputting the supplying power at a power supply output;
a capacitor, coupled to the power supply output, for stabilizing a voltage at the power supply output; and
a hub control module, coupled to the output switch and the capacitor, comprising
a switch, coupled to the capacitor;
a discharge resistor, coupled to the capacitor through the switch;
a control unit for generating a power control signal; and
a logic circuit, coupled to the control unit, the output switch and the switch, for controlling the output switch whether to output the supplying power or not and controlling a conduction state of the switch according to the power control signal;
wherein, when the power control signal instructs the logic circuit to control the output switch not to output the supplying power, the logic circuit controls the switch to be on such that the capacitor discharges through the discharge resistor and the voltage at the power supply output decreases accordingly.

2. The USB hub of claim 1, wherein when the power control signal instructs the logic circuit to control the output switch to output the supplying power, the logic circuit controls the switch to be off to prevent the capacitor from discharging through the discharge resistor.

3. The USB hub of claim 1, wherein the output switch detects a current at the power supply output, and outputs an overcurrent protection signal via an overcurrent protection signal output, which is coupled to the power supply output, to the logic circuit when the current at the power supply output is larger than a predetermined value.

4. The USB hub of claim 3, wherein the overcurrent protection signal output is further coupled to the switch and the capacitor.

5. The USB hub of claim 3, wherein the overcurrent protection signal output is coupled to the power supply output through a protection resistor.

6. The USB hub of claim 3, wherein the control unit changes the power control signal according to the overcurrent protection signal, and the logic circuit selectively outputs the overcurrent protection signal to the control unit.

7. The USB hub of claim 6, wherein when a level at the overcurrent protection signal output transits from low level to high level, the logic circuit outputs the overcurrent protection signal to the control unit.

8. The USB hub of claim 6, wherein when the power control signal instructs the logic circuit to control the output switch not to output the supplying power, the logic circuit does not send the overcurrent protection signal to the control unit.

9. A control module of a USB hub, the USB hub utilizing an output switch to selectively output a supplying power through a power supply output and utilizing a capacitor to stabilize a voltage at the power supply output, the control module comprising:
a switch, coupled to the capacitor;
a discharge resistor, coupled to the capacitor through the switch;
a control unit for generating a power control signal; and
a logic circuit, coupled to the control unit, the output switch and the switch, for controlling the output switch whether to output the supplying power or not and controlling a conduction state of the switch according to the power control signal;
wherein, when the power control signal instructs the logic circuit to control the output switch not to output the supplying power, the logic circuit controls the switch to be on such that the capacitor discharges through the discharge resistor and the voltage at the power supply output decreases accordingly.

10. The control module of claim 9, wherein when the power control signal instructs the logic circuit to control the output switch to output the supplying power, the logic circuit controls the switch to be off to prevent the capacitor from discharging through the discharge resistor.

11. The control module of claim 9, wherein the output switch detects a current at the power supply output, and outputs an overcurrent protection signal via an overcurrent protection signal output, which is coupled to the switch and the capacitor, to the logic circuit when the current at the power supply output is larger than a predetermined value.

12. The control module of claim 11, wherein the control unit changes the power control signal according to the overcurrent protection signal, and the logic circuit selectively outputs the overcurrent protection signal to the control unit.

13. The control module of claim 12, wherein when a level at the overcurrent protection signal output transits from low level to high level, the logic circuit outputs the overcurrent protection signal to the control unit.

14. The control module of claim 12, wherein when the power control signal instructs the logic circuit to control the output switch not to output the supplying power, the logic circuit does not send the overcurrent protection signal to the control unit.

15. A method of controlling a USB hub, the USB hub utilizing an output switch to selectively output a supplying power through a power supply output and utilizing a capacitor to stabilize a voltage at the power supply output, the USB hub further comprising a control unit for outputting a power control signal, the method comprising:
providing a switch;
providing a discharge resistor, coupled to the capacitor through the switch;
controlling the output switch whether to output the supplying power or not according to the power control signal; and
selectively controlling the switch to be off or on according to an output state of the supplying power to make the capacitor charge or discharge through the discharge resistor.

16. The method of claim 15, further comprising:
controlling the switch to be on when the power control signal instructs not to output the supplying power such that the capacitor discharges through the discharge resistor.

17. The method of claim 16, wherein the output switch detects a current at the power supply output and outputs an overcurrent protection signal when the current at the power supply output is larger than a predetermined value, and the control unit changes the power control signal according to the overcurrent protection signal, and the method further comprises:
preventing the control unit from receiving the overcurrent protection signal.

18. The method of claim 15, further comprising:
controlling the switch to be off to prevent the capacitor from discharging through the discharge resistor when the power control signal instructs to output the supplying power.

19. The method of claim 18, wherein the output switch detects a current at the power supply output and outputs an overcurrent protection signal via an overcurrent protection signal output when the current at the power supply output is larger than a predetermined value, and the control unit changes the power control signal according to the overcurrent protection signal, and the method further comprises:
making the control unit receive the overcurrent protection signal when a level at the overcurrent protection signal output transits from low level to high level.
